(19) United States
(12) Patent Application Publication
(10) Pub. No.: US 2007/0163284 A1
(43) Pub. Date: Jul. 19, 2007

(54) Structure of enhancing efficiency in cooling system for kimchi storage

(75) Inventors: Hae Sung Kim, Asan-City (KR); Chang Ick Lee, Cheonan-city (KR); Gui Jin Choi, Cheonan-city (KR)

Correspondence Address: FITZPATRICK CELLA HARPER & SCINTO, 30 ROCKEFELLER PLAZA, NEW YORK, NY, 10112, US

(73) Assignee: WINIA MANDO INC., Asan-city (KR)

(21) Appl. No.: 11/486,256

(22) Filed: Jul. 14, 2006

(30) Foreign Application Priority Data
Jul. 15, 2005 (KR) 2005-64523

(51) Int. Cl. A23G 9/00

(52) U.S. Cl. 62/342

(57) ABSTRACT

Structure for enhancing efficiency in a cooling system for a Kimchi storage containing a plurality of storage chambers includes a compressor, a condenser, a capillary tube, and an evaporator which are sequentially tubularly connected to one another. An accumulator is arranged along a suction pipe (or an inhalation tube) which is an outlet tube of each evaporator associated within each of the plurality of storage chambers. Coolant is sent to and collected in the accumulator from each evaporator through the suction pipe. Simultaneously, the coolant collected in the accumulator is sent to the compressor through s suction pipe (or an exhaust tube). The capillary tube connected between the condenser and the evaporator contacts the accumulator to perform a heat exchange. It is preferable that the capillary tube is arranged to pass through the inside of the accumulator. As a result the pressure of the coolant rises depending upon the temperature rise of the coolant coming out from the evaporator of each storage room to thereby enhance reliability of the compressor.

### BACKGROUND OF THE INVENTION

1. Field of the Invention

The present invention relates to a structure of enhancing efficiency in a cooling system for a Kimchi storage storing Kimchi which is a Korean traditional fermentation food, and more particularly, to a cooling system efficiency enhancement structure for a Kimchi storage in which a capillary tube is arranged to pass through the inside of an accumulator which is arranged along a suction pipe which is an outlet tube of each evaporator which is provided in each of a plurality of storage rooms or chambers in the Kimchi storage, to thereby make the pressure of the coolant rise depending upon the temperature rise of the coolant coming out from the evaporator of each storage room and to thus enhance reliability of the compressor.

2. Description of the Related Art

As is well known, a Kimchi-dedicated storage matures Kimchi which is one of the Korean traditional fermentation food. Such appliances, referred to herein simply as “Kimchi storage”, use a cooling system and a heater and to keep the matured Kimchi fresh. The Kimchi storage properly matures Kimchi stored therein, according to change of seasons and tastes of users, and keeps the matured Kimchi at a proper low temperature in custody to thereby maintain taste and freshness of Kimchi on a long-term basis.

Thus, the use of Kimchi storages is recently gradually increasing by housewives having suffered from difficulties in a long-term storage of Kimchi.

Here, an example of a conventional Kimchi storage will be described with reference to FIGS. 1 and 2.

As shown in FIGS. 1 and 2, a conventional Kimchi storage includes generally a plurality of storage rooms or chambers 4 which are segmented in the upper side of a main body 1 forming the external housing of the appliance. In the conventional Kimchi storage, a plurality of doors 2 opening and closing the plurality of storage chambers 4 are hinge-coupled with the upper end of the rear surface of the main body 1, so that each door can be raised upwards to open each storage chamber.

At the lower side of the storage chambers 4 a segmented machine room or chamber 3 is provided in which a compressor 5 and a condenser 6 for a cooling cycle and a blower 10 for cooling heat which is generated from the condenser 6 are arranged.

Moreover, around the circumference of each storage chamber 4 is provided an evaporator 7 having the structure of a coolant pipe for supplying the coolant through a direct cooling method which is wound around each storage chamber, and arranged with the turns of the pipe located at predetermined intervals around each storage chamber. The evaporators 7 are connected to the compressor 5 and the condenser 6 which are arranged in machine chamber 3 so that a coolant can circulate.

At the lower side of evaporator 7 surrounding each storage chamber 4 is provided a heater 8 which provides the storage chamber 4 with a predetermined heating temperature.

Particularly, at the side where a thermal insulation is needed in the main body 1 is put an insulation material such as a urethane foam through a foam-molding process to thereby obtain an insulation effect.

In the upper front surface of the main body 1 is provided a display manipulator 13 allowing a user to select an aging condition, a keeping time, and a temperature condition according to the kind of the Kimchi stored in the storage chamber 4, and displaying the selected signal.

Therefore, all the control operations for the Kimchi storage are made by a user through the display manipulator 13 equipped on the front surface of the main body 1.

The conventional Kimchi storage having the above-described configuration stores Kimchi using separate Kimchi vessels (not illustrated) which are contained in the storage chambers 4, and performs the aging and the long-term preservation of Kimchi through the temperature control in the storage chambers 4.

The temperature control in the storage chambers 4 is made through the cooling air supply by operation of the cooling system which operates according to a preset control program in a microcomputer (not illustrated) which is connected to the display manipulator 13.

As is well-known, the compressor 5, the condenser 6, and the evaporator 7 constitute a closed loop circuit with a coolant pipe, that is, form a cooling system.

The Kimchi storage having the plurality of storage chambers 4 as described above includes the evaporator 7 supplying each of the plurality of storage rooms 4 with the cooling air. Therefore, a flow rate of the coolant supplied to each evaporator 7 is controlled and smoothly supplied, via a solenoid valve 12.

The solenoid valve 12 is a kind of an on-off valve, in which the coolant flow is maintained at an opening time, and on the other hand, the coolant flow is isolated at a closure time.

In the coolant pipe connecting the exit of the condenser 6 and the entrance of the evaporator 7 is provided a capillary tube 9 whose coolant flow path is very narrow so that the coolant is smoothly evaporated in the evaporator 7.

Moreover, between the exit of the evaporator 7 and the entrance of the compressor 5 is provided a coolant pipe which is called a suction pipe 11. The suction pipe 11 is provided to connect through a base cover 10 which partitions the inner portion of the Kimchi storage into the storage chambers 4 and the machine chamber 3.

The conventional cooling system including each evaporator 7 will be described below in brief. The capillary tubes 9 are disposed and connected in the inlet side of a plurality of evaporators 7, respectively. The cooling system operates at the state where the solenoid valve 12 for controlling the coolant flow in the capillary tube 9 is provided. In this case, the coolant circulation process follows.

That is, the gaseous coolant which has been compressed at high temperature and high pressure in the compressor 5 is heat-exchanged with the neighboring air in the condenser 6 and is changed to a liquid coolant of middle temperature higher than a normal room temperature and high pressure. Subsequently the solenoid valve 12 is selectively opened according to the operation of each evaporator 7.

Accordingly, the liquid coolant of the high pressure flows through the solenoid valve 12 into the capillary tube 9 and then is changed into the liquid coolant of the middle temperature and low pressure while passing through the capillary tube 9.

While the liquid coolant changed to the middle temperature and low pressure flows in the evaporator 7 and is vaporized by a heat-exchange process with the ambient air while passing through the evaporator 7, the storage chambers 4 are cooled by evaporation of the coolant which absorbs heat during evaporation.

The coolant of the gaseous phase passing through the evaporator 7 again flows in the compressor 5 through the suction pipe 11 and is then compressed to high pressure, and then it circulates again in the same cycle as the above-described cooling cycle.

As described above, suction pipe 11 is a coolant pipe through which the gaseous coolant of the low temperature and low pressure evaporated through the heat exchange in the evaporator 7 flows in the compressor 5. Therefore, the coolant escaping from the exit of the evaporator 7 and passing through the suction pipe 11 is maintained at a relatively cool state of the normal room temperature or less.

Due to this, because the coolant temperature flowing into the compressor 5 is low, the inlet temperature of the compressor 5 becomes low. Accordingly, the compression ratio reduction and the efficiency reduction of the compressor 5 are caused to thereby lower the reliability of the compressor 5.

As a result, it is preferable and recommendable that the inlet temperature of the compressor 5 is maintained at the normal temperature. Accordingly, the efficiency of each evaporator 7 is not heightened up to the maximum efficiency, in order to prevent the coolant temperature of the coolant exiting at the exit side of each evaporator 7 from falling down to a predetermined level or less.

Moreover, if the coolant in the suction pipe 11 exists as the liquid phase not the gaseous phase and then introduced into the compressor 5, the compressor 5 may be very highly damaged by a fire.

Thus, an accumulator (not illustrated) is provided between the exit of each evaporator 7 and the entrance of the compressor 5 to prevent the coolant of the liquid phase from being introduced into the compressor 5 to the utmost.

Of course, as necessary, the accumulator includes functions of filtering the impurities and uniformly distributing the coolant.

As described above, in order to solve the problem that the reliability of the compressor 5 is decreased, because the pressure varying range of the coolant coming out from the evaporator 7 of each storage room 4 is large, the various kinds of methods have been needed even in the conventional art.

As one example of the conventional art, the coolant flowing in the inlet side of each evaporator 7, that is, the coolant passing through the capillary tube 9 has a relative high temperature state (a middle temperature state which is relatively lower than the temperature at the compressor 5 of high temperature and high pressure) above the room temperature or greater while passing through the condenser 6.

That is, in the case of the conventional Kimchi storage, the capillary tube 9 is wound on a predetermined length of the suction pipe 11 at the outlet side of each evaporator 7 to secure a contact area widely to the utmost. Accordingly, a heat transfer is performed between the capillary tube 9 and the suction pipe 11. In this manner, the residual liquid coolant in the suction pipe 11 is evaporated and the inlet temperature of the compressor 5 can be maintained closely to the normal room temperature to the utmost. However, it has been difficult to enhance the reliability of the compressor.

### SUMMARY OF THE INVENTION

To solve the above problems of conventional Kimchi storages, it is an object of the present invention to provide a cooling system efficiency enhancement structure for a Kimchi storage in which a capillary tube is arranged to pass through the inside of an accumulator which is arranged along a suction pipe which is an outlet tube of each evaporator which is provided in each of a plurality of storage chambers in the Kimchi storage, to thereby make the pressure of the coolant rise up depending upon the temperature rise of the coolant coming out from the evaporator of each storage chamber and to thus enhance reliability of the compressor.

To accomplish the above object of the present invention, there is provided a cooling system efficiency enhancement structure for a Kimchi storage having a plurality of storage chambers including a cooling system including a compressor, a condenser, a capillary tube, an evaporator which are sequentially tubularly connected to one another. An accumulator is arranged along a suction pipe which is an outlet tube of each evaporator which is wound around each of the plurality of storage chambers.

A coolant is sent to and collected in the accumulator from each evaporator through the suction pipe (or an inhalation tube), and the coolant collected in the accumulator is simultaneously sent to the compressor through the suction pipe (or an exhaust tube). As a result the capillary tube connected between the condenser and the evaporator contacts the accumulator to thus perform a heat exchange.

It is preferable that the capillary tube is arranged to pass through the inside of the accumulator.

It is also preferable that the upper entrance of the suction pipe or the exhaust tube which sends the coolant from the inside of the accumulator to the compressor is located at a higher position than the lower exit of the suction pipe or the inhalation tube into which the coolant transferred from the evaporator.

### BRIEF DESCRIPTION OF DRAWINGS

The above and other objects and advantages of the present invention will become more apparent by describing the preferred embodiment thereof in more detail with reference to the accompanying drawings in which:

FIG. 1 is a perspective view showing an example of a conventional Kimchi storage storing Kimchi which is one of the Korean traditional fermentation food;

FIG. 2 is a sectional view schematically showing the internal configuration of a conventional Kimchi storage;

FIG. 3 is a perspective view showing the state that a capillary tube is arranged into an accumulator installed along a suction pipe which is provided at the outlet side of each evaporator in each storage room in a Kimchi storage to which the present invention is applied; and

FIG. 4 is a partially cut-away perspective view showing the state that a capillary tube is arranged into an accumulator installed along a suction pipe which is provided at the outlet side of each evaporator in each storage room in a Kimchi storage to which the present invention is applied.

### DETAILED DESCRIPTION OF THE INVENTION

Hereinafter, a cooling system efficiency enhancement structure for a Kimchi storage according to a preferred embodiment of the present invention will be described with reference to the accompanying drawings.

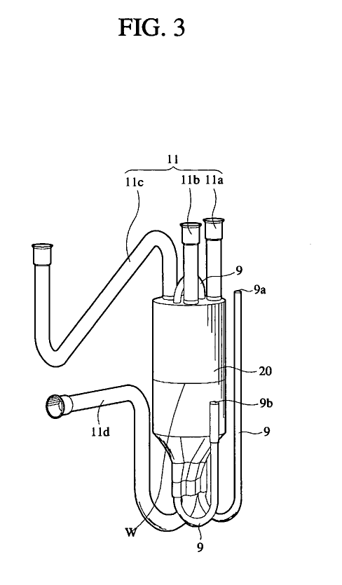

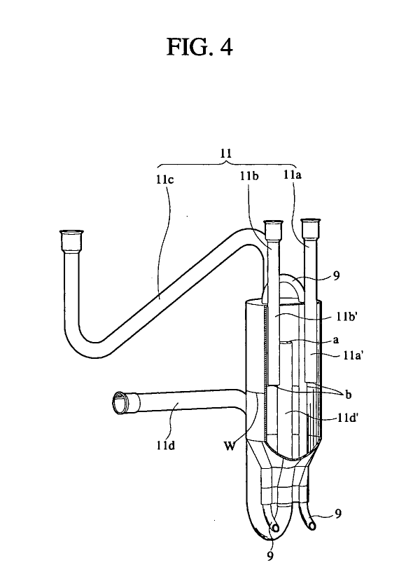

FIG. 3 is a perspective view showing the state that a capillary tube is arranged into an accumulator installed along a suction pipe which is provided at the outlet side of each evaporator in each storage room in a Kimchi storage to which the present invention is applied, and FIG. 4 is a partially cut-away perspective view showing the state that a capillary tube is arranged into an accumulator installed along a suction pipe which is provided at the outlet side of each evaporator in each storage room in a Kimchi storage to which the present invention is applied.

Here, a configuration of a Kimchi storage other than the technical features of the present invention is identical with a conventional Kimchi storage. Accordingly, the general configuration and function of the Kimchi storage to which the present invention is applied will quote those of the conventional art and a detailed description thereof will be omitted. Moreover, the same elements of the present invention as those of the conventional art are assigned with the same reference numerals as those of the conventional art except for the technical features of the present invention.

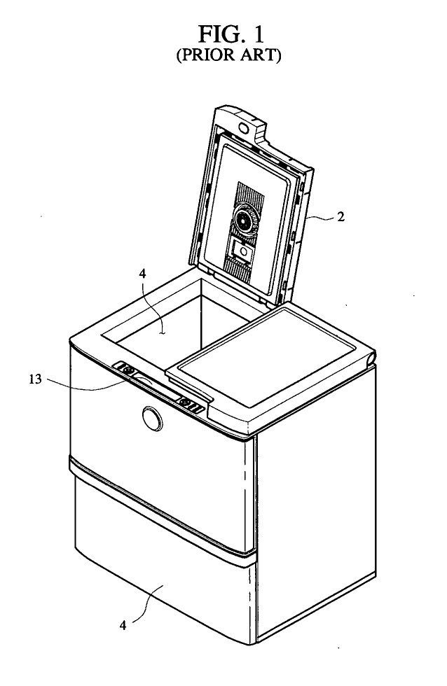

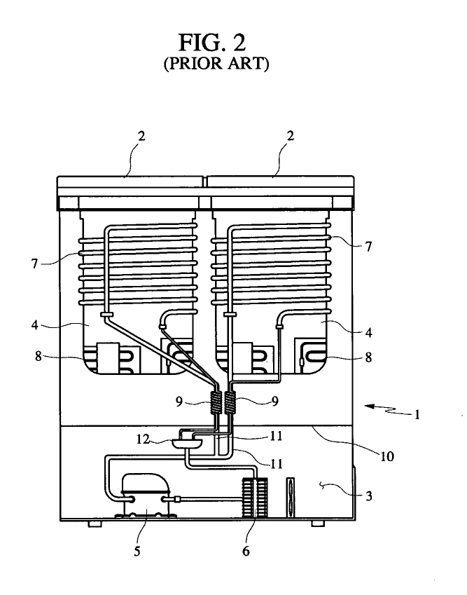

That is, in the same structure as those of the conventional technique, as shown in the attached drawings FIGS. 1 and 2, a Kimchi storage according to the present invention includes a main body 1 having a machine chamber 3 in which and a compressor 5 and a condenser 6 are arranged in order to form a cooling cycle system and a plurality of storage chambers 4 which are surrounded by a respective evaporator 7 of the cooling cycle system.

Each evaporator 7 mutually communicates with the compressor 5 and the condenser 6 which are arranged in the machine chamber 3 through a coolant pipe so that a coolant can circulate.

Further, along the coolant pipe connecting the exit of the condenser 6 and the entrance of the evaporator 7 is provided a capillary tube 9 whose flow path of the coolant is very narrow, so that the coolant is smoothly evaporated in the evaporator 7.

In the same manner as that of the conventional technology, a coolant pipe which is called a suction pipe is provided between the exit of the respective evaporator 7 and the entrance of the compressor 5. The suction pipe 11 is provided to connect through a base cover 10 which partitions the inner portion of the Kimchi storage into the storage chambers 4 and the machine chamber 3.

As illustrated in FIG. 3, the accumulator 20 is arranged along the suction pipe 11 and the coolant coming out from the evaporator 7 of each storage chamber 4 is collected in the accumulator 20, and then sent to the compressor 5.

That is, the accumulator 20 has a liquid-phase coolant isolation function, in order to prevent the coolant of the liquid state included in the gaseous coolant coming from the evaporator 7 of each storage room 4 from being introduced into the compressor 5 to the utmost, and to filter the impurities as necessary, and a uniform distribution function of the coolant.

In the accumulator 20 having the above-described structure according to the present invention, the capillary tube 9 connected to the condenser 6 is arranged to pass through the inside of the accumulator 20.

After the capillary tube 9 connected to the condenser 6 passes the accumulator 20, the coolant is controlled by a stepping valve (not illustrated) and can be selectively supplied to the evaporator 7 of each storage room 4.

This is to make heat exchange possibly performed between the accumulator 20 and the capillary tube 9.

That is, since there is a clear temperature difference between the coolant passing through the capillary tube 9 and the coolant gathered from each evaporator 7 to the accumulator 20, a mutual heat exchange can be made between the coolant in the capillary tube 9 and the coolant in the accumulator 20.

Because the temperature of the coolant collected in the accumulator 20 from each evaporator 7 is relatively lower than that of the coolant which passes through the capillary tube 9 and is supplied to the evaporator 7, the coolant temperature of the capillary tube 9 descends additionally due to the heat which is deprived of during the heat exchange time. In the meantime, since the temperature of the coolant gathered in the accumulator 20 rises up, an effect that the temperature of the coolant sent to the compressor 5 from the accumulator 20 becomes relatively high can obtained.

Likewise, if the temperature rise occurs in the coolant sent to the compressor 5 from each evaporator 7, the coolant pressure rises up relatively in comparison with the conventional case, and a pressure varying range of the coolant is reduced. Thus, the reliability of the compressor 5 is enhanced.

In the meantime, and, if more concretely, the layout structure of each suction pipe 11 which is connected between the evaporator 7 and the compressor 5 of each storage chamber 4 in the accumulator 20, and the layout structure of the capillary tube will be described in more detail with reference to FIG. 4.

As shown in FIG. 4, accumulator 20 is formed of a cylindrical structure whose diameter is very large relatively in comparison with the suction pipe 11. A plurality of suction pipes 11a, 11b, and 11c respectively connected to the evaporators 7 of each storage chamber 4 are arranged on the upper end of the accumulator 20. In the illustrated embodiment, three storage chambers are provided and pipes 11a, b and c are arranged as shown in FIG. 4. One suction pipe 11d connected to the compressor 5 is arranged and exits near the lower portion of the accumulator 20.

The capillary tube 9 is arranged to penetrate between the upper and lower portions of the accumulator 20 in a U-shaped form.

That is, as shown in FIG. 3, one end 9a of the capillary tube 9 is connected to the condenser 6 and one end 9b of the capillary tube 9 is connected to the evaporator 7 and both extend from the bottom of the accumulator 20. One extension of the U-shaped bent capillary tube 9 is exposed at the upper end portion of the accumulator 20.

It is preferable that the body of the cylindrical accumulator 20 is divided into upper and lower portions which are assembled through mutual welding “w.”

This is to make the U-shaped capillary tube 9 which is penetratively arranged in the accumulator 20 easily installed and makes the accumulator 20 easily manufactured.

Particularly, since it is preferable that the accumulator 20 has a liquid-phase coolant separation function, the upper portion “a” of the suction pipe (which may be referred to as an exhaust tube 11d′) connected from the inside of the accumulator 20 to the compressor 5 is positioned above the lower portion “b” of the suction pipes (which may be referred to as inhalation tubes 11a′, 11b′, and 11c′) connected from the evaporator 7.

Therefore, the liquid-phase coolant included in the coolant collected in the accumulator 20 from the evaporator 7 through the suction tubes 11a′, 11b′, and 11c′ is unable to be introduced into the entrance of the upper portion “a” of the exhaust line 11d′ moving out to the side of the compressor 5, and is collected in the inner bottom of the accumulator 20. Only the gaseous coolant included in the coolant collected in the accumulator 20 is introduced into the entrance of the upper portion “a” of the exhaust line 11d′ which is positioned above the lower portion “b” of the suction tubes 11a′, 11b′, and 11c′, and thus only the gaseous coolant is transferred to the compressor 5.

As described above, the cooling system efficiency enhancement structure for a Kimchi storage according to the present invention has an effect that a capillary tube is arranged to pass through the inside of an accumulator which is arranged along a suction pipe which is an outlet tube of each evaporator which is provided in each of a plurality of storage chambers in the Kimchi storage, to thereby make the pressure of the coolant rise up depending upon the temperature rise of the coolant coming out from the evaporator of each storage room and to thus enhance reliability of the compressor.

As described above, the present invention has been described with respect to particularly preferred embodiments. However, the present invention is not limited to the above embodiments, and it is possible for one who has an ordinary skill in the art to make various modifications and variations, without departing off the spirit of the present invention. Thus, the protective scope of the present invention is not defined within the detailed description thereof but is defined by the claims to be described later and the technical spirit of the present invention.

What is claimed is:

1. A cooling system efficiency enhancement structure for a Kimchi storage containing a plurality of storage chambers comprising:
a cooling system including a compressor, a condenser, a capillary tube, an evaporator associated with each of said storage chambers which are sequentially tubularly connected to one another; and
an accumulator arranged along a suction pipe which is an outlet tube of each evaporator to receive and collect coolant from each evaporator, said coolant collected in the accumulator being simultaneously sent to the compressor and said capillary tube being connected between the condenser and the evaporator in contact with the accumulator to perform a heat exchange.

2. The cooling system efficiency enhancement structure for a Kimchi storage of claim 1, wherein the capillary tube is arranged to pass through the inside of the accumulator.

3. The cooling system efficiency enhancement structure for a Kimchi storage of claim 1 or 2, wherein the evaporator is connected to the accumulator through an inhalation tube, and the accumulator is connected to the compressor by a suction pipe, and the upper entrance of the suction pipe of the exhaust tube which sends the coolant from the inside of the accumulator to the compressor is located at a higher position than the lower exit of the inhalation tube into which the coolant is transferred from the evaporator.
